(19) United States
(12) Patent Application Publication
(10) Pub. No.: US 2001/0027380 A1
(43) Pub. Date: Oct. 4, 2001

(54) Method of using a finger print sensor

(76) Inventor: Christofer Hierold, Munchen (DE)

Correspondence Address: LERNER AND GREENBERG, P.A., Post Office Box 2480, Hollywood, FL, 33022-2480, US

(21) Appl. No.: 09/796,215

(22) Filed: Feb. 28, 2001

(30) Foreign Application Priority Data
Feb. 28, 2000 (DE) 100 09 348.5

(51) Int. Cl. G01L 7/00

(52) U.S. Cl. 702/139

(57) ABSTRACT

A bearing pressure exerted on the finger print sensor or a change in this bearing pressure is ascertained using defined grey-scale value portions of one or more successively recorded finger print images, and in the event of a specific bearing pressure being exceeded and/or undershot or in the event of a predetermined dimension for the change in the bearing pressure being exceeded, a control signal and/or useful signal is generated or a function of the finger print sensor or of an electrical or electronic device connected thereto is controlled or switched.

### BACKGROUND OF THE INVENTION

### Field of the Invention

The present invention relates to a method for the use of a finger print sensor in which the recorded image depends on the bearing pressure of the finger.

In the case of finger print sensors which effect capacitive measurement, a grid-shaped arrangement of conductor areas which form the individual sensor elements is situated on a sensor area or sensor surface. The image quality, in particular contrast and brightness, generated by the sensor depends on how firmly a finger tip is placed on the bearing area of the finger print sensor. If the finger is placed only lightly, then the result is an image having a small area and only small dark grey portions. If the finger is pressed firmly on the sensor, then the area of the finger print image is enlarged and the grey portions in the image are shifted toward darker values.

### SUMMARY OF THE INVENTION

It is accordingly an object of the invention to provide a method of use for a finger print sensor, which overcomes the above-mentioned disadvantages of the heretofore-known devices and methods of this general type and which demonstrates possible ways of improving the operation or use of a finger print sensor.

With the foregoing and other objects in view there is provided, in accordance with the invention, a fingerprint acquisition method for a finger print sensor for recording a finger print image which changes with a change in a bearing pressure exerted on a bearing area of the finger print sensor.

The method comprises:

determining a number and/or distribution of pixels lying in a relevant portion of the finger print image or having predetermined grey-scale values, or a change thereof in successively recorded finger print images is determined; and

if a predetermined threshold value for the number and/or distribution is exceeded or undershot or if a predetermined threshold value for the change thereof is exceeded, generating one of a control signal and useful signal or appropriately controlling a function of one of the finger print sensor and a device connected thereto.

In accordance with an added feature of the invention, the function of the finger print sensor is switched from a standby operating state into an operating state of full functionality, or into a standby operating state.

In accordance with an additional feature of the invention, an alive recognition is performed from the change in the number and/or distribution, and the alive recognition is used to decide whether a function of the finger print sensor or of the device connected thereto is controlled or switched.

In accordance with a concomitant feature of the invention, a signal is generated that represents the bearing pressure and a protective function is triggered if a predetermined threshold value for the bearing pressure is exceeded.

In other words, the effect of a bearing pressure exerted on the bearing area of the finger print sensor, or of a change in the bearing pressure, on the image generated is ascertained. To that end, the area occupied by the recorded finger print image is determined, or the number and/or distribution of pixels in which defined and, if appropriate, suitably normalized grey-scale values are present, or the change thereof in a plurality of successively recorded finger print images is determined. From this, it is possible to draw conclusions about the bearing pressure of the finger tip or the change therein. In the event that a predetermined limit value for the number and/or distribution of pixels which are relevant for the recorded finger print image (in the sense that these pixels do not belong to a purely white or black and therefore insignificant partial area of the image) is exceeded and/or undershot or have a defined grey-scale value, or in the event of the exceeding of a predetermined limit value for the change in the grey-scale value portion in a plurality of successively recorded finger print images, a control signal and/or useful signal is generated or a function of the finger print sensor or a connected device is controlled or switched. The method according to the invention thus makes it possible for at least one additional function to be controlled by the operation of placing a finger tip on the sensor, which is otherwise not possible if only the finger print image as such is recorded.

For example, the finger print sensor may be operated in a standby operating state which minimizes the current consumption. In the event of an increase in the bearing pressure on the bearing area, the size of the image changes, and the grey-scale value portion rises, so that the finger print sensor is switched on from the standby operating state and yields finger print images with the desired resolution; in the event of a subsequent decrease in the bearing pressure, the finger print sensor is switched off into the standby operating state. In the standby operating state, for example, only a specific small number of individual sensor elements are driven, so that the grey-scale value portions thereof can be determined. This selected number of pixels may be distributed in a predetermined manner over the whole area of the bearing area of the sensor or else be concentrated on the center of the sensor area. The driving of the sensor is considerably simplified in this standby operating state; and the evaluation of the signals that have been determined can be restricted to the determination of grey-scale value portions in a relatively coarse gradation.

A further possibility opened up by the method consists in switching on a further electrical or electronic device or an apparatus in dependence on the bearing pressure ascertained. This may, for example, involve a display apparatus which, owing to the high current consumption or wear, should only be switched on when the finger print sensor is utilized, but whose switch-on does not have to be coupled to the identification of persons. Such additional functions which are not directly connected with the recording of the finger print image can be switched using the method according to the invention without necessitating an extensive additional technical outlay therefor.

The method can also be used to achieve a dynamic, user-dependent assessment of the operation for recording images of the finger print. If the sensor image is generated rapidly enough, typically about 10 images per second, for example, then the dynamic alteration of the finger print image on account of a change in the bearing pressure can be used to distinguish living fingers from counterfeiting attempts (alive recognition). A further possibility consists, in safety-relevant applications, by detecting the—possibly greatly increased—bearing pressure, in ascertaining whether the person utilizing the finger print is threatened, and in initiating appropriate measures by means of signals communicated electronically. The finger print sensor can thus be provided with a protective function which consists in normal placement of the finger tip leading to the customary operating mode of the sensor, but very firm pressing triggering an emergency alarm or the like.

I claim:

1. A fingerprint acquisition method, which comprises:
providing a finger print sensor for recording a finger print image which changes with a change in a bearing pressure exerted on a bearing area of the finger print sensor;
determining a number and/or distribution of pixels lying in a relevant portion of the finger print image or having predetermined grey-scale values, or a change thereof in successively recorded finger print images is determined; and
if a predetermined threshold value for the number and/or distribution is exceeded or undershot or if a predetermined threshold value for the change thereof is exceeded, generating one of a control signal and useful signal or appropriately controlling a function of one of the finger print sensor and a device connected thereto.

2. The method according to claim 1, wherein the controlling step comprises switching a function of the finger print sensor from a standby operating state into an operating state of full functionality.

3. The method according to claim 1, wherein the controlling step comprises switching a function of the finger print sensor into a standby operating state.

4. The method according to claim 1, which comprises carrying out an alive recognition from the change in the number and/or distribution, and using the alive recognition to decide whether a function of the finger print sensor or of the device connected thereto is controlled or switched.

5. The method according to claim 1, which comprises generating a signal representing the bearing pressure and triggering a protective function, if a predetermined threshold value for the bearing pressure is exceeded.
